(19) United States
(12) Patent Application Publication
(10) Pub. No.: US 2013/0124344 A1
(43) Pub. Date: May 16, 2013

(54) METHOD AND SYSTEM FOR DETERMINING USER LIKELIHOOD TO SELECT AN ADVERTISEMENT PRIOR TO DISPLAY

(71) Applicants: Venkateswarlu Kolluri, Shrewsbury, MA (US); Alden DoRosario, South Grafton, MA (US); Vijay Mookerjee, McKinney, TX (US); Radha Mookerjee, McKinney, TX (US); Chris Caswell, Brinhton, MA (US)

(72) Inventors: Venkateswarlu Kolluri, Shrewsbury, MA (US); Alden DoRosario, South Grafton, MA (US); Vijay Mookerjee, McKinney, TX (US); Radha Mookerjee, McKinney, TX (US); Chris Caswell, Brinhton, MA (US)

(21) Appl. No.: 13/603,014

(22) Filed: Sep. 4, 2012

Related U.S. Application Data
(60) Provisional application No. 61/559,548, filed on Nov. 14, 2011.

(51) Int. Cl. G06Q 30/02

(52) U.S. Cl. 705/14.73

(57) ABSTRACT

A computer implemented system and method of determining whether to display an advertisement to a user can include determining, using at least one processor, a likelihood that a user accessing a web page would select an advertisement if displayed to the user in the web page at a future moment during that trip by the user to the web page. An analysis module can determine whether or not the determined likelihood satisfies criteria imposed by a click-through-rate associated with the web page. If the determined likelihood value satisfies the click-through-rate, then an advertisement can be output to the user through at least one output device. Otherwise, the system can refrain from causing an advertisement to be output to the user for inclusion in the web page during that particular visit by the user to the web page.

### RELATED APPLICATIONS

This application claims priority to, and the benefit of, co-pending U.S. Provisional Application No. 61/559,548, filed Nov. 14, 2011, for all subject matter common to both applications. The disclosure of said provisional application is hereby incorporated by reference in its entirety.

### FIELD OF THE INVENTION

The present invention relates to advertising networks, as well as advertisement displays that satisfy one or more constraints. More specifically, the present invention provides systems and methods for determining the likelihood that a user would select an advertisement on a web page that the user is accessing if displayed to the user with the web page at some point in the future.

### BACKGROUND

In online advertising, an advertising agency acts as an intermediary between individuals/companies publishing content online (e.g., “content publishers”) and companies and/or individuals wishing to place advertisements alongside the content publishers' online content. Content publishers can include bloggers, online websites, and the like. Advertising networks typically acquire permission to serve advertisements on websites of a wide variety of content publishers. Advertising networks further aggregate advertisements from a plurality of different advertisers. When a user browsing the web visits a web page that has been configured to allow ad serving by the advertising network, the advertising network sends an advertisement to the user's user device, which is subsequently displayed to the user in the content publisher's web page.

Many existing content publishers demand that the advertising agency serve ads with a reasonable amount of efficiency. One way such efficiency is measured is through a “click-through-rate.” A web page's “click-through-rate” is determined by dividing the number of times an advertisement displayed with (e.g., on) the web page by the advertising agency was selected by a user (i.e., the number of “click-throughs”) by the number of instances in which an advertisement was displayed with the web page (i.e., the number of “ad impressions”). Accordingly, the click-through-rate is equal to the ratio of click-throughs to ad impressions.

In general, many advertising networks attempt to maximize the number of “click-throughs” a web page receives by displaying as many advertisements with the web page as possible. However, this practice tends to greatly increase the number of ad impressions for a particular web page, which typically results in lower overall click-through-rates (CTRs) by indiscriminately displaying a maximum quantity of ads to every visitor of the web page.

Moreover, an additional shortcoming of the above-mentioned tactic for increasing a web page's “click-throughs” is that many visitors to web pages (and content publishers) find it undesirable for advertising agencies to indiscriminately present a large quantity of advertisements, which result in low CTRs. In fact, visitors to a web page may be less likely to return to the web page if the web page is saturated with advertisements. For this reason, many content publishers are equally concerned with their web page's CTR as their ad revenues from click-throughs generated by the web page. Accordingly, some content publishers impose CTR requirements or targets for advertising agencies to meet or strive to meet. However, many existing ad networks fail to provide suitable mechanisms for exercising discretion in determining the circumstances under which an ad should be displayed. As such, existing systems fail to provide adequate click-through-rates and CTR goals that meet the needs of many online content publishers.

### SUMMARY

There is a need in the art for systems and methods that provide more efficient advertisement displays, higher click-through-rates, and greater discretion in choosing when to display and when to not display an advertisement. The present invention is directed to solutions to address this and other needs, as well as having other benefits that will be appreciated by one of skill in the art upon reading the present specification.

In accordance with embodiments of the present invention, a computer implemented method for determining whether to display an advertisement to a user, includes receiving, through at least one input device, a request from a user device based on a user navigating to a web page. A likelihood that the user would click on an advertisement if presented to the user with the web page is determined, using at least one processor, based on the received request. The method continues with predicting, using at least one processor, whether a click-through-rate associated with the web page would be met or exceeded if an advertisement were presented to the user with the web page. The predicting step is based on the determined likelihood. If it is predicted that the click-through-rate associated with the web page would be met or exceeded if an advertisement were presented to the user, the method causes an advertisement to be output through at least one output device and displayed to the user with the web page on at least one presentation device.

In accordance with aspects of the present invention, the step of predicting whether the click-through-rate associated with the web page would be met or exceeded if an advertisement were presented to the user with the web page can include: generating, using at least one processor, a likelihood value on a predefined scale representing the likelihood that the user would click on an advertisement if presented to the user with the web page; converting, using at least one processor, the generated likelihood value into a predicted click-through-rate; and comparing, using at least one processor, the predicted click-through-rate to the click-through-rate associated with the web page.

In accordance with aspects of the present invention, the step of predicting whether the click-through-rate associated with the web page would be met or exceeded if an advertisement were presented to the user with the web page can include: generating, using at least one processor, a likelihood value for the user representing the likelihood that the user would click on an advertisement if presented to the user with the web page; based on the click-through-rate, determining, using at least one processor, a likelihood value associated with the web page; and comparing, using at least one processor, the generated likelihood value that the user will click on an advertisement to the likelihood value associated with the web page.

In accordance with further aspects of the present invention, the step of causing the advertisement to be output through at least one output device and displayed to the user with the web page can include selecting, using at least one processor, the advertisement. The click-through-rate can be a predetermined click-through-rate designated by a content host associated with the web page.

In accordance with further aspects of the present invention, the step of determining the likelihood that the user would click on an advertisement if presented to the user with the web page can include generating a likelihood value representing a likelihood that the user would click on any advertisement if presented to the user with the web page. The step of determining the likelihood that the user would click on an advertisement if presented to the user with the web page can include generating a likelihood value representing a likelihood that the user would click on any advertisement of a particular type if presented to the user with the web page. The step of determining the likelihood that the user would click on an advertisement if presented to the user with the web page can include generating a likelihood value representing a likelihood that the user would click on a specific advertisement if presented to the user with the web page.

In accordance with aspects of the present invention, the likelihood that the user would click on an advertisement if presented to the user with the web page can be determined based on one or more of: browsing history of the user, clicking history of the user, purchase history of the user, demographic information of the user, a user client being utilized by the user to navigate to the web page, a browsing time at which the user accessed the web page, a referrer to the web page, content that was searched by the user, activity history for the web page, impression history for the web page, or clicking history for the web page.

In accordance with embodiments of the present invention, a computer implemented system for determining whether to display an advertisement to a user can include at least one input device configured to receive a request from a user device based on a user navigating to a web page. At least one output device, at least one processor, at least one non-transitory data storage device containing instructions can be provided. The output device, processor, and storage can implement the instructions in such a way that, when executed, cause the at least one processor to: determine, based on the received request, a likelihood that the user would click on an advertisement if presented to the user with the web page; predict, based on the determined likelihood, whether a click-through-rate associated with the web page would be met or exceeded if an advertisement were presented to the user with the web page; and if it is predicted that the click-through-rate associated with the web page would be met or exceeded if an advertisement were presented to the user, cause an advertisement to be output through the at least one output device and displayed to the user with the web page on at least one presentation device.

In accordance with aspects of the present invention, execution of the instructions can cause the at least one processor to predict whether the click-through-rate associated with the web page would be met or exceeded if an advertisement were presented to the user with the web page by: generating a likelihood value on a predefined scale representing the likelihood that the user would click on an advertisement if presented to the user with the web page; converting the generated likelihood value into a predicted click-through-rate; and comparing the predicted click-through-rate to the click-through-rate associated with the web page.

In accordance with aspects of the present invention, execution of the instructions can cause the at least one processor to predict whether the click-through-rate associated with the web page would be met or exceeded if an advertisement were presented to the user with the web page by: generating a likelihood value for the user representing the likelihood that the user would click on an advertisement if presented to the user with the web page; determining, based on the click-through-rate, a likelihood value associated with the web page; and comparing the generated likelihood value that the user will click on an advertisement to the likelihood value associated with the web page. Execution of the instructions can further cause the at least one processor to select the advertisement output through the at least one output device.

In accordance with aspects of the present invention, the click-through-rate can be a predetermined click-through-rate designated by a content host associated with the web page.

In accordance with aspects of the present invention, the determined likelihood that the user would click on an advertisement if presented to the user with the web page can include a likelihood value representing a likelihood that the user would click on any advertisement if presented to the user with the web page. The determined likelihood that the user would click on an advertisement if presented to the user with the web page can include a likelihood value representing a likelihood that the user would click on any advertisement of a particular type if presented to the user with the web page. The determined likelihood that the user would click on an advertisement if presented to the user with the web page can include a likelihood value representing a likelihood that the user would click on a specific advertisement if presented to the user with the web page.

In accordance with aspects of the present invention, the likelihood that the user would click on an advertisement if presented to the user with the web page can be determined based on one or more of: browsing history of the user, clicking history of the user, purchase history of the user, demographic information of the user, a user client being utilized by the user to navigate to the web page, a browsing time at which the user accessed the web page, a referrer to the web page, content that was searched by the user, activity history for the web page, impression history for the web page, or clicking history for the web page. The click-through-rate associated with the web page can be a required minimum click-through-rate imposed by a content host associated with the web page.

In accordance with embodiments of the present invention, a computer implemented method for determining whether to display an advertisement to a user can include receiving, through at least one input device, a request from a user device, the request being generated based on a user navigating to a web page. Using at least one processor, a likelihood value can be generated representing a likelihood that the user would click on an advertisement if presented to the user. Using at least one processor, a determination can be made as to whether the generated likelihood value satisfies a click-through-rate. If the generated likelihood value is determined to satisfy the click-through-rate, through at least one output device, an advertisement can be output to the user device.

### BRIEF DESCRIPTION OF THE FIGURES

These and other characteristics of the present invention will be more fully understood with reference to the following detailed description in conjunction with the attached drawings, in which:

FIG. 1 is an illustrative diagram of a system for determining whether or not to display an advertisement, according to an example embodiment of the present invention;

FIG. 2 is an example method for generating a likelihood value for a user and causing one or more advertisements to be displayed or not displayed based on the generated likelihood value, according to aspects of the present invention;

FIG. 3 is an example method for performing decision analysis, according to aspects of the present invention;

FIG. 4 is an illustrative diagram of user information that can be utilized in determining whether to display an ad to a user, according to aspects of the present invention;

FIG. 5 is an illustrative diagram of additional information that can be utilized in determining whether to display an ad to a user, according to aspects of the present invention; and

FIG. 6 is an example embodiment of a computing system for implementing the system of FIG. 1, according to aspects of the present invention.

### DETAILED DESCRIPTION

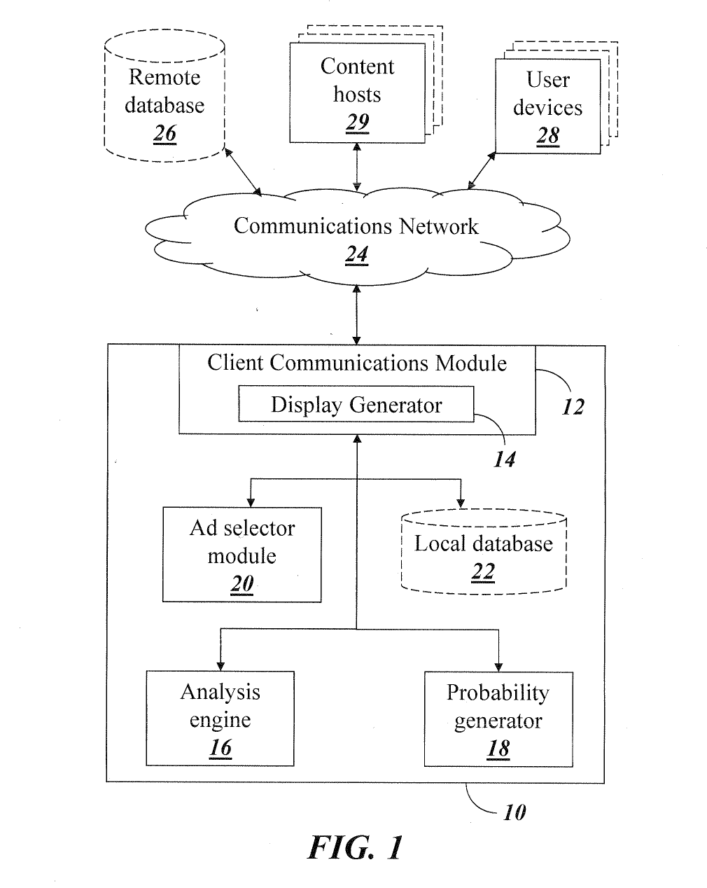

FIGS. 1 through 6, wherein like parts are designated by like reference numerals throughout, illustrate example embodiments of a method and system for determining whether to display an advertisement to a particular user, according to the present invention. Although the present invention will be described with reference to the example embodiments illustrated in the figures, it should be understood that many alternative forms can embody the present invention. One of skill in the art will additionally appreciate different ways to alter the parameters of the embodiments disclosed, in a manner still in keeping with the spirit and scope of the present invention.

FIG. 1 depicts an example embodiment of a system 10 for determining whether or not to display an advertisement to a user based on a calculated likelihood that the user will click on an advertisement. The system 10 generally can include a client communications module 12, which can include a display generator 14 configured to generate one or more interactive displays of information, e.g., which contain one or more selectable advertisements. The system 10 further can include an analysis engine 16 configured to perform one or more analyses based on or more criteria or requirements, such as a minimum value for a click-through-rate. The system 10 can include a probability generator 18 configured to generate (e.g., determine, calculate, etc.) likelihood values (e.g., probabilities) each representing a likelihood that a user will click on an advertisement if such an advertisement is served to the user at some point in the future. For example, the likelihood value can represent a likelihood that serving an advertisement to the user in response to a received request (e.g., HTTP request) to serve an ad will indeed result in the user clicking on the advertisement during his or her active viewing session of a particular website. Accordingly, the likelihood value can provide a relative prediction of whether the user will click on an advertisement on a particular website if such an advertisement is presented to the user in the future.

The system further can include an advertisement (“ad”) selector module 20 for selecting advertising content to be included in displays generated by the display generator 14. One or more local databases 22 can be included in the system for storing a plurality of different information, as will be described in greater herein. All of the various components of the system 10 can be logically connected and in communication with one another.

In addition to one or more local databases 22, the system 10 also can communicate with one or more remote databases 26, such as virtual databases, cloud databases, and/or other remote databases. The system 10 further can communicate with any number of additional (e.g., remote) computing devices, including user devices 28 (e.g., client devices being operated by a user), content hosts 29 (e.g., web servers or any other suitable computing devices hosting information, such as on a website), or any other computing devices, as understood by those of skill in the art. All communication can be established across a communications network 24 (e.g., the Internet, or any other type of communications network), as will be appreciated by one of skill in the art. The content hosts 29 generally include any computing device that hosts or publishes information, typically referred to as a “publisher” of information within the context of advertising schemes. For example, in embodiments implemented for the Internet, the content hosts 29 can include computing devices implemented for bloggers (or blog websites), news websites, or any other website that hosts information.

The display generator 14 is configured to generate one or more interactive displays of information. The one or more interactive displays of information that are generated by the display generator 14 can include interactive advertisements. For example, interactive advertisements can contain selectable hyperlinks that, when selected, redirect to a web page designated by an advertiser associated with the advertisement. In general, it should be appreciated that the interactive advertisement displays generated by the display generator 14 need not advertise any specific product for sale, service for sale, etc. Rather, the advertisements alternative can include selectable hyperlinks to, e.g., information websites. In general, the advertisements generated herein can be any selectable display of information, as will be appreciated by one of skill in the art.

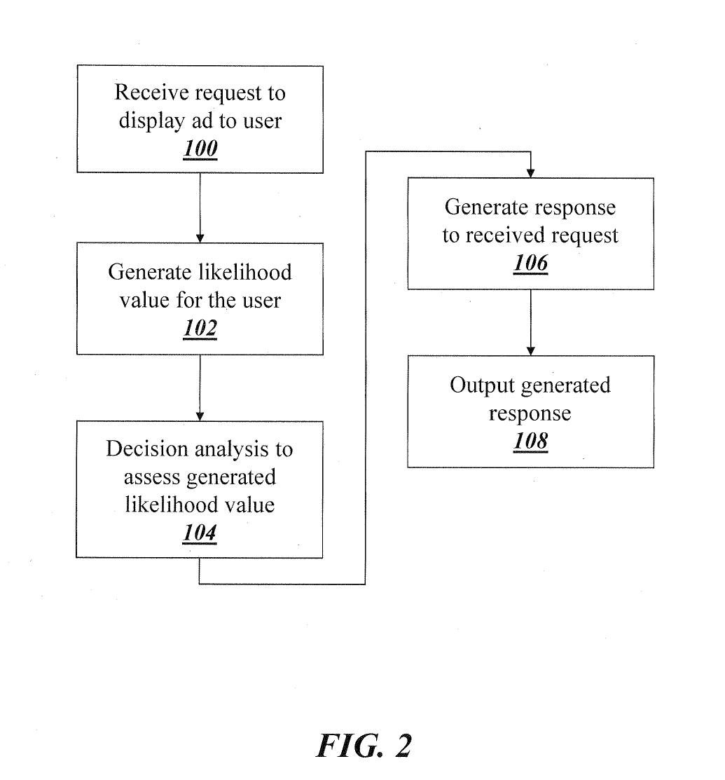

The system 10 generally can be configured to assess a likelihood that a given user will select (e.g., click on) an advertisement in the future during an active viewing session for a particular website. This can be used, for example, to determine whether or not to display an advertisement to a user with (e.g., on) the web page being accessed (e.g., requested for viewing) by the user. For example, FIG. 2 depicts an example method by which the system 10 can perform such a determination. The communications module 12 receives, through at least one input device, a request to display an advertisement or to determine whether to display an advertisement to a particular user (step 100). The request can be transmitted as a result of the user accessing (e.g., requesting to view) a particular web page. For example, a user viewing search results from a search engine website can click on one of the links contained in the search results. This can cause the user's user device 28 to transmit a request over the communications network 24 to the client communications module 12 in the system 10. Alternatively, this request can be routed through a content host 29 (e.g., a web server) that hosts the website currently being requested by the user.

Based on the request received in step 100, the probability generator 18 can cause one or more processors to generate a likelihood value for the user that submitted the request in step 100 (step 102). The likelihood value generally represents a likelihood that displaying an advertisement with the web page requested by the user will result in a selection by that user of the advertisement (e.g., a “click-through”). More specifically, the likelihood value can represent a “prediction” or estimate of how likely the user is to select an advertisement that is displayed to the user on the requested web page during the user's active viewing session of that web page. Accordingly, in illustrative embodiments, the likelihood value is only a measure of the user's likelihood to select an advertisement during that particular active viewing session of the web page. However, in other embodiments, the likelihood value can be, can include, or can be based at least in part on, a general likelihood value that the user will click on an advertisement that is displayed on any web page.

The analysis engine 16 can cause a decision analysis to be performed by one or more processors (step 104). The decision analysis can include an assessment of whether the generated likelihood value for the user satisfies one or more criteria that must be met for the system 10 to cause an advertisement to be displayed to the user on the particular website that the user is accessing. In an illustrative embodiment, the decision analysis is based on a criterion that in many instances can be imposed by the content hosts 29 (e.g., “publishers”): a required minimum click-through-rate (CTR), as would be appreciated by one of skill in the art. Alternatively, the required minimum CTR can be provided by (and imposed by) the system 10. Accordingly, the analysis engine 16 can cause one or more processors to evaluate the generated likelihood value for the user based on the required minimum click-through-rate for the web page being accessed or the particular content host 29 providing the web page being accessed.

Accordingly, based on the likelihood value generated in step 102, the analysis engine 16 in step 104 generally can predict, using at least one processor, whether a click-through-rate associated with the web page being requested by the user would be met or exceeded if an advertisement (e.g., any advertisement generally, any advertisement of a specific type, a specific advertisement, etc.) were presented to the user with the web page. Stated differently, in step 104, the analysis engine 16 can determine whether the generated likelihood value would “satisfy” a click-through-rate associated with the web page by using the generated likelihood value generate a prediction of whether the web page would meet or exceed the associated click-through-rate if an advertisement (e.g., any advertisement generally, any advertisement of a specific type, a specific advertisement, etc.) were presented to the user with the web page. For example, in some embodiments according to the present invention, the analysis engine 16 determines whether the generated likelihood value is sufficiently high such that presenting an advertisement (e.g., any advertisement generally, any advertisement of a specific type, a specific advertisement, etc.) to the user with the web page would produce an outcome that sufficiently contributes to the web page meeting or exceeding the associated click-through-rate.

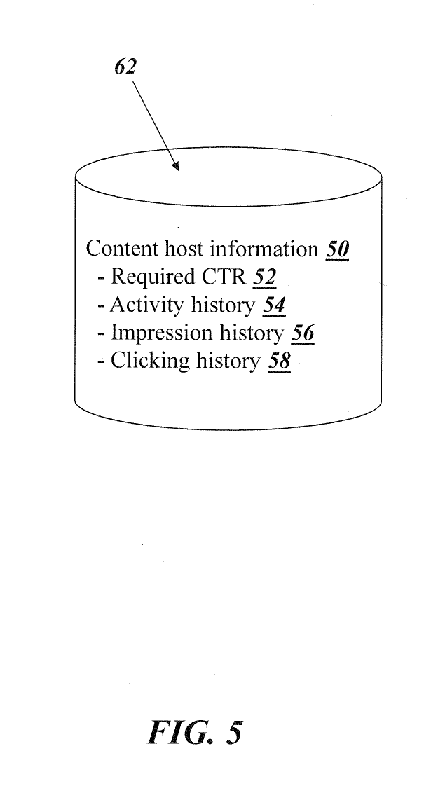

As described in further detail herein with reference to FIG. 5, the analysis of step 104 (e.g., generating the prediction of whether the required minimum CTR for the web page would be satisfied if an advertisement were presented to the user with the web page) can be confined a particular defined (e.g., predetermined) period of time, and can be based on a variety of factors, information, and projections. For example, such factors, information, and projections can include the web page's past, current, and/or activity history (e.g., over the defined period of time); the web page's past, current, and/or impression history (e.g., over the defined period of time); and/or the web page's past, current, and/or future clicking history (e.g., over the defined period of time). The predication generally can be based on estimates of current/past clicking activity, visitor activity, impression activity, etc., and can be based on projections of future clicking activity, visitor activity, impression activity, etc. Furthermore, the prediction can be based on actual historical values, as would be appreciated by one of skill in the art upon reading the present specification.

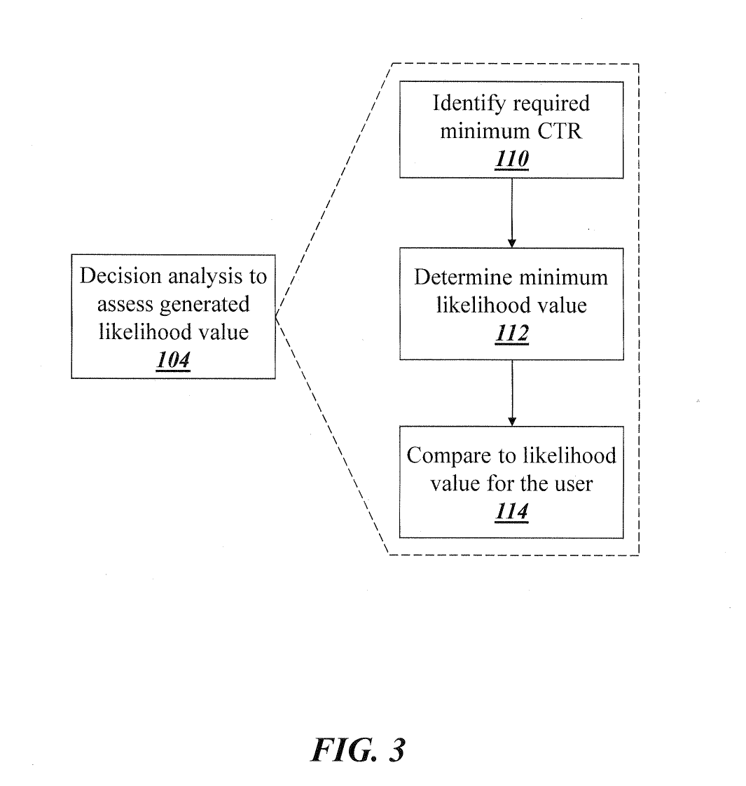

For example, FIG. 3 depicts an example method for performing the decision analysis of step 104 of assessing the generated likelihood value based on one or more criteria and predicting whether the required minimum CTR associated with the web page would be satisfied if an advertisement were presented to the user with the web page. Based on the request received in step 100, the analysis engine 16 can cause one or more processors to identify (e.g., to retrieve from a database) a value of a required minimum click-through-rate. For example, the required minimum CTR can be specifically associated with the web page, can be associated with the website in which the web page is included, or can be associated with the content host 29 providing the requested web page (step 110). In illustrative embodiments, such values of the required minimum click-through-rates for websites and/or content hosts 29 are stored in the databases 22, 26, and thus are easily retrievable by the system 10 in step 110.

The analysis engine 16 can cause one or more processors to determine a minimum likelihood value based at least in part on the identified (e.g., retrieved) value of the required minimum click-through-rate (step 112). More specifically, the minimum likelihood value can represent a minimum likelihood that, if met by the user, statistically would result in the minimum required click-through-rate being met over some period of time. Accordingly, the minimum likelihood value can be determined based not only on the required minimum click-through-rate, but also on other factors, such as: (a) a particular time period being evaluated; (b) whether the required minimum click-through-rate applies to the web page being accessed, applies to a website to which the web page belongs, or applies more broadly to the content host 29 (e.g., for all websites/web pages provided by the content host 29); (c) a number of “click-throughs” that have accumulated during the particular time period being evaluated (e.g., a number of click-throughs for the web page, the website, the content host 29, etc.); and/or (d) a number of advertisement “impressions” (i.e., a number of times an advertisement has been caused by the system 10 to be displayed) for the web page, the website, or the content host 29 during the time period being evaluated, and other information, as will be appreciated by one of skill in the art upon reading the present specification. Any of these values that can be a function of time (e.g., the number of “click-throughs” accumulated during the particular time period and the number of ad impressions during the particular time period) can be based on actual measurements (e.g., by tracking activity of the website/content host 29 during the particular time period), or can be approximated values (e.g., based on historical values, stored approximations, and any other approximation). One of skill in the art will appreciate a variety of different ways to determine the minimum likelihood value based on these and other factors upon reading the present specification.

Accordingly, continuing with FIG. 3, the determined minimum likelihood value can be compared to the determined likelihood value for the user (step 114). If the likelihood value for the user meets or exceeds the minimum likelihood value imposed by the required minimum click-through-rate, then the system 10 can cause an advertisement to be displayed. If the likelihood value for the user does not meet or exceed the minimum likelihood value imposed by the required minimum click-through-rate, then the system 10 can refrain from displaying an advertisement. For example, continuing with FIG. 2, once the generated likelihood value for the user is assessed in the decision analysis of step 104, the client communications module 12 can cause one or more processors to generate a response to the request received in step 100. The response can include one or more commands to display an advertisement or can include one or more commands to not display an advertisement. Any command to display an advertisement can include one or more particular advertisements to be displayed, which can be selected by the ad selector module 20, received from a remote or local ad server, etc. The generated response can be output by the system 10 through at least one output device (step 108). Accordingly, the response that is output in step 108 can be received by the user device 28 from which the initial request was received, and can thereby cause one, some, or no advertisements to be displayed on one or more presentation components of the user device 28.

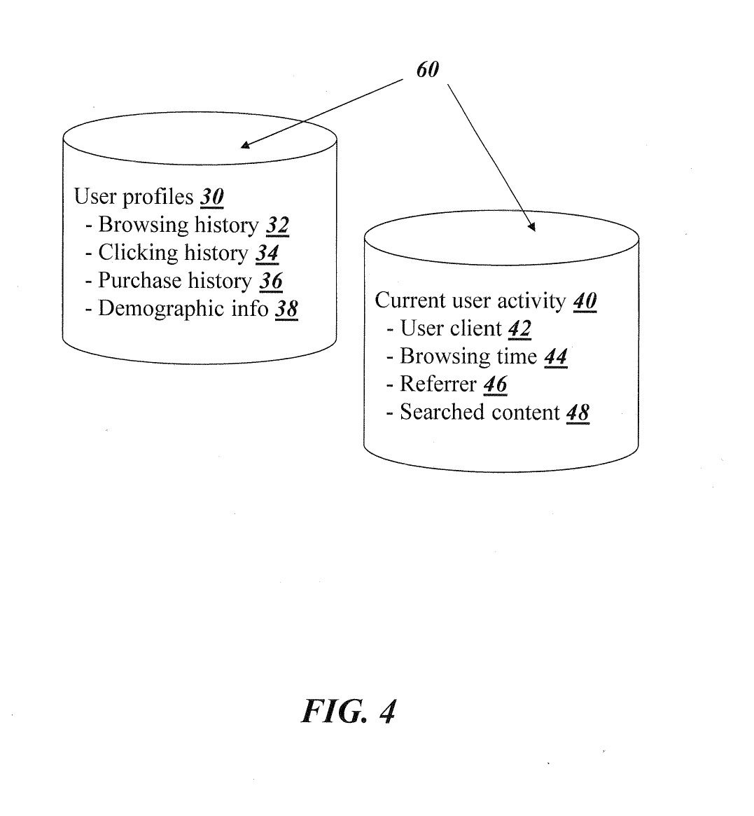

Many different types of information can be used to generate the likelihood value for the user. FIG. 4 depicts several illustrative examples of user information 60 that can be utilized by the system 10 for performing step 102 of generating the likelihood value.

For example, the user information 60 can include user profiles 30, which can contain a plurality of user-specific information, such as browsing histories 32, clicking histories 34, purchase histories 36, demographic information 38, and any other suitable information. The browsing histories 32 can include recent and past browsing history by users (e.g., activity on particular websites for which user browsing activity is tracked), search engine histories, or any other browsing histories. The clicking histories 34 can include records of users' previous interactions with the advertisements served by the system 10 (e.g., a record of which particular advertisements were previously selected by users, which particular advertisements were previously presented but not selected, etc.). The purchase histories 36 can include any information about online purchase by users, including third-party purchasing data mined by external computing systems. The demographic information 38 similarly can include mined data containing demographic facts about users, such as age, residence, income, ethnicity, political affiliation, etc. Alternatively or additionally, some or all of the user information can be submitted to the system 10 by the users.

One of skill in the art will appreciate that the user information 60 and user profiles 30 can include or be based on many different possible variables and types of information, only some of which have been identified here in the above illustrative examples. As such, the present invention is by no means limited to the specific examples provided herein. Furthermore, one of skill in the art will appreciate that the likelihood value for the user can be generated based on information that is specific to the web page (e.g., content of the information, popularity of the web page, etc.).

In addition, the user information 60 that is used to generate a likelihood value for a user accessing a web page can include information pertaining to the particular present instance of the user accessing the web page, referred to herein as current user activities 40. For example, the current user activities 40 can include an identification of a particular user client 42 that is being used by a user to access the web page. For example, in embodiments implemented for the Internet, the user client 42 information can include (e.g., per instance of a user accessing a web page) an identification of a particular web browser (e.g., Mozilla Firefox, Internet Explorer®, Google Chrome™, Netscape®, etc.) being using to access the web page. The current user activity 40 can also include a browsing time 44 of day (e.g., relative to the user's local time zone) at which the web page was initially accessed. Furthermore, a referrer 46 (e.g., an “HTTP referer,” as would be appreciated by one of skill in the art) can also be used to generate the likelihood value, e.g., for each instance of a user accessing a web page. As would be appreciated by one of skill in the art upon reading the present specification, the referrer can indicate a previous web page from which a user navigated to a web page being accessed. As just one illustrative example, the referrer 46 can be used to distinguish search engine referrers from “non-search engine” referrers. Furthermore, for a user viewing a web page that was referred by a search engine, searched content 48 (e.g., search terms entered by the user into the search engine website) can also be used to determine the likelihood value, e.g., for each instance of a user accessing a web page. Again, the present invention is by no means limited to these above examples. Rather, one of skill in the art will appreciate many additional user activities and user information that can be utilized in embodiments of the present invention. All such alternatives and modifications are contemplated within the scope of the present invention. Any suitable information can be used to generate the likelihood value in step 104.

In general, the user information 60 depicted in FIG. 4 is received by the system 10, e.g., in the request received in step 100. Optionally, the user information 60 can be stored locally or remotely (e.g., stored in the databases 22, 26, on the user devices 28), or can be used by the system 10 on a one-time basis (e.g., only in the instance of determining the likelihood value for the user). In illustrative embodiments, the user information 60 of FIG. 4 is received by the system 10 from the user devices 28 in step 100 and is stored in the databases 22, 26 or on the user devices 28 (e.g., in the form of cookies). Accordingly, the system 10 can actively track some or all of the user information 60 of FIG. 4, e.g., as users navigate to web pages on which the system 10 serves advertisements.

Furthermore, in embodiments where the user information 60 of FIG. 4 is stored in the databases 22, 26, the user information 60 generally can be stored in any suitable form and can be organized and categorized as will be appreciated by one of skill in the art, e.g., according to index records, metadata, tags, etc. In illustrative embodiments, the user-specific information is uniquely identifiable with a specific user device 28, e.g., in the form of IP addresses. Alternative mechanisms can be used for associating information contained in the user profiles 30 with specific users in a manner suitable for being tracking, storage, and proper identification of such information with particular users.

The decision analysis of step 104 generally can include a plurality of algorithms that determine whether the likelihood value generated for the user in step 102 satisfy a click-through-rate associated with the web page (e.g., a required minimum click-through-rate imposed by a content host 29 providing the web page, or a content host 29 providing the content of the web page, etc.). For example, the decision analysis of step 104 can include execution (with at least one processor) of a plurality of algorithms that effectively “converts” a required minimum click-through-rate into a minimum required likelihood value, as described previously herein with reference to FIG. 3. Accordingly, additional information about the content host 29 also can be used to perform the decision analysis in step 104. FIG. 5 depicts examples of such additional information 62 that can be used to perform the decision analysis in step 104. The additional information 62 generally can include content host information 50, such as a required or minimum CTR value 52 for one or more websites and/or web pages (e.g., as imposed by a particular content host 29); current or past visitor activity histories 54 (e.g., numbers of visitors to web pages and/or websites of the content hosts 29); impression histories 56 (e.g., numbers of impressions presented with the web pages and/or websites of the content hosts 29); and clicking histories 58 (e.g., numbers of visitors to the webpages and/or websites of the content host 29 that “clicked through” an advertisement displayed by the client communications module 12). This and other information can be used to perform the decision analysis. Stated differently, step 112 of “converting” the required minimum click-through-rate into the minimum likelihood value (which is compared to the likelihood value for the user determined in step 114) can be based on any of the additional information 62 of FIG. 5. Accordingly, in accordance with an example embodiment, the decision analysis includes the analysis engine 16 causing one or more processors to determine a minimum likelihood value based on the required minimum click-through-rate 52, as well as one or more of: the activity histories 54 for the particular web page being accessed, the impression histories 56 for the particular webpage being accessed, and/or the clicking histories 58 for the particular web page being accessed.

Illustrative embodiments of the present invention have been described with reference to determining a user's likelihood value for selecting an advertisement. More specifically, in illustrative embodiments, the likelihood value represents a likelihood that a user would select, during the active viewing session of a particular web page being accessed, any advertisement, regardless of and non-specific to the content of the advertisement, the category or type of the advertisement, the source of the advertisement, and/or other attributes of the advertisement. Alternatively, in accordance with some embodiments of the present invention, the likelihood value represents a likelihood that a user would select, during the active viewing session of a particular web page being accessed, any advertisement having particular attribute (e.g., particular content, particular ad category or type, particular source, etc.). In yet other embodiments, the likelihood value represents a likelihood that a user would select, during the active viewing session of a particular web page being accessed, a specific advertisement with specific content.

Accordingly, in accordance with some embodiments of the present invention, the likelihood value generated in step 104 can be specific to one or more types of advertisements, or can be specific to one or more advertisements. In such embodiments, the user information 60 can include information that is specific to particular types or instances of advertisements (e.g., specific to particular advertisement attributes or specific to particular advertisements), so as to facilitate the system 10 in step 102 of generating the likelihood value. Utilizing greater granularity in determining likelihood values (i.e., generating likelihood values that are specific to particular types or instances of advertisements) can be useful in situations where users' likelihoods of clicking on an advertisement vary widely with the type of advertisement or even the particular advertisement.

For example, the likelihood that a particular user living in Hawaii will select an advertisement related to “beach gear” may be higher than the likelihood that the user will select an advertisement related to “skiing equipment.” Accordingly, such demographic information can be useful in the system 10 determining whether or not to display advertisements pertaining to these particular categories based on residence. As yet another example, users having recently conducted a search on a search engine for “free computer application downloads” may be less likely to click on an advertisement for computers than users having recently conducted a search on a search engine for “best computer for me.”

One of skill in the art will appreciate a wide variety of ways to implement user likelihood values that are specific to particular types of advertisements, particular advertisements, and the like. For example, in step 102, a plurality of different likelihood values can be determined for a single user, each being specific to a particular type of advertisement. Each of the different likelihood values then can be assessed in the decision analysis of step 104. If more than one generated likelihood value meets or surpasses the minimum required likelihood value determined in step 112, then the highest likelihood value generated in step 102 can be used to determine which advertisement to serve on the user device 28. These and many other alternatives are possible and contemplated within the scope of the present invention.

Furthermore, although the illustrative embodiments described herein refer to a single user, it will be readily appreciated that the methods, data storage, functions, and systems provided herein can be implemented for many different users all having different associated information, likelihoods, preferences, browsing activities, etc.

It should be appreciated that the particular decision analysis depicted and described herein with reference to FIG. 3 is illustrative and in no way limits the present invention. Many other decision analyses can be utilized to assess the generated likelihood value based on one or more criteria, such as a required minimum click-through-rate. For example, rather than determining a minimum likelihood value in step 112, the likelihood value for the user determined in step 102 instead can “converted” into an expected click-through-rate. The expected click-through-rate that is determined based on the likelihood value for the user then can be compared to the identified (e.g., retrieved) required minimum click-through-rate. Many additional alternatives are possible for assessing the generated likelihood value based on the required minimum click-through-rate, as will be appreciated by one of skill in the art upon reading the present specification. All such alternatives are contemplated within the scope of the present invention.

Any suitable computing device can implement the system 10 and the methods described herein. For example, the computing device can include one or more server devices, e.g., logically coupled and in communication with each other. Accordingly, the modules, generators, and engines of FIG. 1 generally can be implemented as executable instructions contained in one or more non-transitory computer readable storage devices included in the computing device, one or more input devices, one or more output devices, etc., as would be appreciated by one of skill in the art.

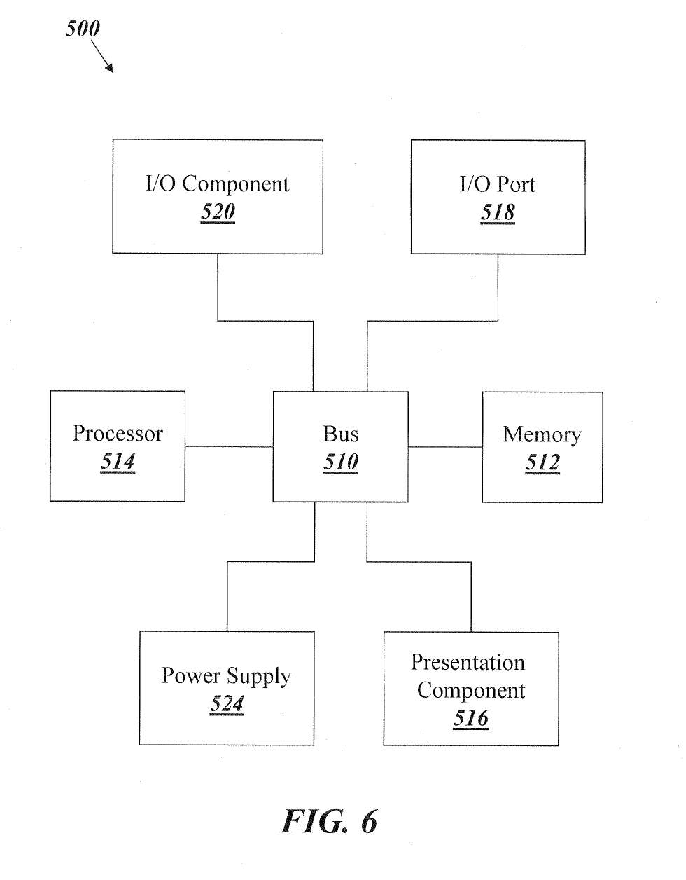

FIG. 6 illustrates an example of a computing device 500 for implementing illustrative methods and systems of the present invention. The computing device 500 is merely an illustrative example of a suitable computing environment and in no way limits the scope of the present invention. A “computing device,” as represented by FIG. 6, can include a “workstation,” a “server,” a “laptop,” a “desktop,” a “hand-held device,” a “mobile device,” a “tablet computer,” or other computing devices, as would be understood by those of skill in the art. Given that the computing device 500 is depicted for illustrative purposes, embodiments of the present invention may utilize any number of computing devices 500 in any number of different ways to implement a single embodiment of the present invention. Accordingly, embodiments of the present invention are not limited to a single computing device 500, as would be appreciated by one with skill in the art, nor are they limited to a single type of implementation or configuration of the example computing device 500.

The computing device 500 can include a bus 510 that can be coupled to one or more of the following illustrative components, directly or indirectly: a memory 512, one or more processors 514, one or more presentation components 516, input/output ports 518, input/output components 520, and a power supply 524. One of skill in the art will appreciate that the bus 510 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 6 is merely illustrative of an exemplary computing device that can be used to implement one or more embodiments of the present invention, and in no way limits the invention.

The computing device 500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 500.

The memory 512 can include computer-storage media in the form of volatile and/or nonvolatile memory. The memory 512 may be removable, non-removable, or any combination thereof. Exemplary hardware devices are devices such as hard drives, solid-state memory, optical-disc drives, and the like. The computing device 500 can include one or more processors that read data from components such as the memory 512, the various I/O components 516, etc. Presentation component(s) 516 present data indications to a user or other device. Exemplary presentation components include a display device, speaker, printing component, vibrating component, etc.

The I/O ports 518 can allow the computing device 500 to be logically coupled to other devices, such as I/O components 520. Some of the I/O components 520 can be built into the computing device 500. Examples of such I/O components 520 include a microphone, joystick, recording device, game pad, satellite dish, scanner, printer, wireless device, networking device, and the like.

One of skill in the art will appreciate a wide variety of ways to modify and alter the system 10 of FIG. 1, as well as the various components with which it interacts. For example, the databases 22, 26 can be implemented according to any number of suitable database structures. Furthermore, some or all of the information contained in the local database 22 alternatively can be stored in the remote database 26. Additionally, although the components of FIG. 1 are depicted as discrete blocks and elements, in fact the system 10 may be implemented in such a way that multiple of the depicted modules, engines, or other components are implemented with just a single module, engine, or component. Similarly, in some embodiments it may be desirable to implement the system 10 using multiple iterations of the depicted modules, engines, and/or other components, as would be appreciated by one of skill in the art. Furthermore, while some modules and components are depicted as included within the system 10, it should be understood that, in fact, any of the depicted modules alternatively can be excluded from the system 10 and included in a different system. One of skill in the art will appreciate a variety of other ways to expand, reduce, or otherwise modify the system 10 upon reading the present specification.

Accordingly, embodiments of the present invention can enable the system 10 to determine, on a case-by-case basis, whether or not to serve an advertisement to a user based on facts specific to each instance. Notably, the system 10 provided herein determines (e.g., for each instance in which a user accesses a web page configured to allow the system 10 to serve advertisements thereon) a likelihood that a user accessing such a web page would click on an advertisement in the web page during that particular visit to the web page if such an advertisement were displayed on/with the web page. This is performed in the illustrative embodiments by generating a likelihood value for the user that represents a likelihood that a user would click on an advertisement if such an advertisement were displayed with the web page at some point in the future. Beneficially, the likelihood value for the user can be based on a wide variety of information, including, as non-limiting examples, information specific to the user (e.g., browsing histories 32, clicking histories 34, purchase histories 36, demographic information 38, user client 42 being used to access the web page, browsing time 44 at which the web page was accessed, referrer 46 of the web page, searched content 48, etc.). Accordingly, a different likelihood value can be generated for a single user in each instance that the user accesses a web page configured to allow the system 10 to serve advertisements thereon. Using such user information 60 can allow the system 10 to generate an extremely accurate prediction of the likelihood that the user would click on an advertisement if presented with the web page being accessed or requested. One of skill in the art will appreciate a wide variety of other types of information that can be used when determining the likelihood value. All such alternatives and modifications are contemplated within the scope of the present invention.

Furthermore, as described previously herein, the generated likelihood value for the user in that particular instance of the user accessing the web page can be used to determine whether or not to display an advertisement with the web page. In accordance with illustrative embodiments of the present invention, the generated likelihood value can be determined as either satisfying or failing to satisfy a required minimum click-through-rate 52 associated with the web page (e.g., a required minimum CTR 52 set for the web page, a required minimum CTR 52 set for a website containing the web page, a required minimum CTR 52 set for a content host 29 associated with the web page or numerous such web pages, etc.). In particular, information associated with the particular web page being visited (e.g., the activity histories 54 of the web page, the impression histories 56 of the web page, the clicking histories 58 of the web page, etc.) can be used to “convert” the required minimum click-through-rate 52 into a required minimum likelihood value associated with the web page being accessed. More specifically, the required minimum likelihood value can be generated based on the required minimum CTR 52 and the additional information 62 associated with the web page. Alternatively, the generated likelihood value for the user can be “converted” into a predicted click-through-rate for the web page that would result if an advertisement is presented to the user. As with the generated likelihood value, the required minimum likelihood value and/or the predicted click-through-rate for the web page can change over time, e.g., as any of the additional information 62 associated with the web page changes (or as predictions of such values change).

Embodiments of the present invention thus can enable a wide variety of functionalities. The likelihood values can enable substantially higher click-through-rates to be achieved for such web pages by refraining from serving or preventing the serving of advertisements to users that are highly unlikely to “click through” during that particular visit to the web page. Such restrictions would cause fewer impressions on a given web page, thereby reducing the click-through-rate for the web page. Accordingly, this can improve the click-through-rate for many web pages, websites, and content hosts 29. Furthermore, this can allow the system 10 to refrain from undesirably overcrowding web pages with advertisements. Those of skill in the art will appreciate yet further benefits upon reading the present specification.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A computer implemented method for determining whether to display an advertisement to a user, the method comprising:
receiving, through at least one input device, a request from a user device based on a user navigating to a web page;
based on the received request, determining, using at least one processor, a likelihood that the user would click on an advertisement if presented to the user with the web page;
based on the determined likelihood, predicting, using at least one processor, whether a click-through-rate associated with the web page would be met or exceeded if an advertisement were presented to the user with the web page; and
if it is predicted that the click-through-rate associated with the web page would be met or exceeded if an advertisement were presented to the user, causing an advertisement to be output through at least one output device and displayed to the user with the web page on at least one presentation device.

2. The computer implemented method of claim 1, wherein the step of predicting whether the click-through-rate associated with the web page would be met or exceeded if an advertisement were presented to the user with the web page comprises:
generating, using at least one processor, a likelihood value on a predefined scale representing the likelihood that the user would click on an advertisement if presented to the user with the web page;
converting, using at least one processor, the generated likelihood value into a predicted click-through-rate; and
comparing, using at least one processor, the predicted click-through-rate to the click-through-rate associated with the web page.

3. The computer implemented method of claim 1, wherein the step of predicting whether the click-through-rate associated with the web page would be met or exceeded if an advertisement were presented to the user with the web page comprises:
generating, using at least one processor, a likelihood value for the user representing the likelihood that the user would click on an advertisement if presented to the user with the web page;
based on the click-through-rate, determining, using at least one processor, a likelihood value associated with the web page; and
comparing, using at least one processor, the generated likelihood value that the user will click on an advertisement to the likelihood value associated with the web page.

4. The computer implemented method of claim 1, wherein the step of causing the advertisement to be output through at least one output device and displayed to the user with the web page comprises selecting, using at least one processor, the advertisement.

5. The computer implemented method of claim 1, wherein the click-through-rate is a predetermined click-through-rate designated by a content host associated with the web page.

6. The computer implemented method of claim 1, wherein the step of determining the likelihood that the user would click on an advertisement if presented to the user with the web page comprises generating a likelihood value representing a likelihood that the user would click on any advertisement if presented to the user with the web page.

7. The computer implemented method of claim 1, wherein the step of determining the likelihood that the user would click on an advertisement if presented to the user with the web page comprises generating a likelihood value representing a likelihood that the user would click on any advertisement of a particular type if presented to the user with the web page.

8. The computer implemented method of claim 1, wherein the step of determining the likelihood that the user would click on an advertisement if presented to the user with the web page comprises generating a likelihood value representing a likelihood that the user would click on a specific advertisement if presented to the user with the web page.

9. The computer implemented method of claim 1, wherein the likelihood that the user would click on an advertisement if presented to the user with the web page is determined based on one or more of: browsing history of the user, clicking history of the user, purchase history of the user, demographic information of the user, a user client being utilized by the user to navigate to the web page, a browsing time at which the user accessed the web page, a referrer to the web page, content that was searched by the user, activity history for the web page, impression history for the web page, or clicking history for the web page.

10. A computer implemented system for determining whether to display an advertisement to a user, the system comprising, comprising:
at least one input device configured to receive a request from a user device based on a user navigating to a web page;
at least one output device;
at least one processor; and
at least one non-transitory data storage device containing instructions that, when executed, cause the at least one processor to:
determine, based on the received request, a likelihood that the user would click on an advertisement if presented to the user with the web page;
predict, based on the determined likelihood, whether a click-through-rate associated with the web page would be met or exceeded if an advertisement were presented to the user with the web page; and
if it is predicted that the click-through-rate associated with the web page would be met or exceeded if an advertisement were presented to the user, cause an advertisement to be output through the at least one output device and displayed to the user with the web page on at least one presentation device.

11. The system of claim 10, wherein execution of the instructions causes the at least one processor to predict whether the click-through-rate associated with the web page would be met or exceeded if an advertisement were presented to the user with the web page by:
generating a likelihood value on a predefined scale representing the likelihood that the user would click on an advertisement if presented to the user with the web page;
converting the generated likelihood value into a predicted click-through-rate; and
comparing the predicted click-through-rate to the click-through-rate associated with the web page.

12. The system of claim 10, wherein execution of the instructions causes the at least one processor to predict whether the click-through-rate associated with the web page would be met or exceeded if an advertisement were presented to the user with the web page by:
generating a likelihood value for the user representing the likelihood that the user would click on an advertisement if presented to the user with the web page;
determining, based on the click-through-rate, a likelihood value associated with the web page; and
comparing the generated likelihood value that the user will click on an advertisement to the likelihood value associated with the web page.

13. The system of claim 10, wherein execution of the instructions further causes the at least one processor to select the advertisement output through the at least one output device.

14. The system of claim 10, wherein the click-through-rate is a predetermined click-through-rate designated by a content host associated with the web page.

15. The system of claim 10, wherein the determined likelihood that the user would click on an advertisement if presented to the user with the web page comprises a likelihood value representing a likelihood that the user would click on any advertisement if presented to the user with the web page.

16. The system of claim 10, wherein the determined likelihood that the user would click on an advertisement if presented to the user with the web page comprises a likelihood value representing a likelihood that the user would click on any advertisement of a particular type if presented to the user with the web page.

17. The system of claim 10, wherein the determined likelihood that the user would click on an advertisement if presented to the user with the web page comprises a likelihood value representing a likelihood that the user would click on a specific advertisement if presented to the user with the web page.

18. The system of claim 10, wherein the likelihood that the user would click on an advertisement if presented to the user with the web page is determined based on one or more of: browsing history of the user, clicking history of the user, purchase history of the user, demographic information of the user, a user client being utilized by the user to navigate to the web page, a browsing time at which the user accessed the web page, a referrer to the web page, content that was searched by the user, activity history for the web page, impression history for the web page, or clicking history for the web page.

19. The system of claim 10, wherein the click-through-rate associated with the web page is a required minimum click-through-rate imposed by a content host associated with the web page.

20. A computer implemented method for determining whether to display an advertisement to a user, the method comprising:
receiving, through at least one input device, a request from a user device, the request being generated based on a user navigating to a web page;
generating, using at least one processor, a likelihood value representing a likelihood that the user would click on an advertisement if presented to the user;
determining, using at least one processor, whether the generated likelihood value satisfies a click-through-rate; and
if the generated likelihood value is determined to satisfy the click-through-rate, outputting, through at least one output device, an advertisement to the user device.
